(19) United States
(12) Patent Application Publication
(10) Pub. No.: US 2001/0046181 A1
(43) Pub. Date: Nov. 29, 2001

(54) Multiple component mixing and dispensing system

(76) Inventors: William C. Paetow II, Pinckney, MI (US); Carl L. Schultz SR., Plymouth, MI (US)

Correspondence Address: Andrew R. Basile, Young & Basile, P.C., Suite 624, 3001 West Big Beaver Road, Troy, MI, 48084, US

(21) Appl. No.: 09/776,615

(22) Filed: Feb. 2, 2001

Related U.S. Application Data
(60) Provisional application No. 60/180,569, filed on Feb. 4, 2000.

(51) Int. Cl. B01F 15/02

(52) U.S. Cl. 366/177.1; 366/181.8

(57) ABSTRACT

An apparatus for mixing a plurality of fluids to form a mixture of predetermined mixture ratios. The fluids are mixed from a plurality of sources, wherein the ratios are controlled by metering cylinders, and each cylinder is in fluid communication with a single fluid source. Each metering cylinder is operated by a corresponding lever, wherein each lever provides individual control over the stroke of each corresponding metering cylinder. The levers are connected to a single actuator for movement in unison, and for greater control in delivering and maintaining the desired mixture ratios of fluids to a receiving chamber.

### CROSS-REFERENCE TO RELATED APPLICATIONS

This application claims the benefit of U.S. Provisional Application Ser. No. 60/180,569, filed Feb. 4, 2000.

### BACKGROUND OF THE INVENTION

The present invention relates generally to two, three, or more component metering systems, and more particularly to such metering systems for use with water based paint applications.

Multiple component water based paints are available. Typically, these include three components: two paint components and a water component. In applying water based paints in uncontrolled environments, the components are generally hand mixed to specifications defined by the environment and applied in small batches. For example, known aircraft paint mixing methods include batch methods. In the batch method, containers of a catalyst component, a base component, and a reducing component are prepared separately and then poured into a large container where the mixture is manually stirred. After an induction waiting period (required for some paint systems) the paint is transferred to the point-of-use where the paint is then applied. The paint is usually applied with a hand held pressurized spray gun. This process has proven to be burdensome and, therefore, a need has arisen for an improved system.

Two component metering systems are known in the art for high volume output. Conventionally, two component paints are formed by directing each of the components through a separate metering device, such as a metering gear pump, progressive cavity pump, or other pumps, then intermixing them within a static or dynamic mixer prior to dispensing onto a substrate or into a holding reservoir. These types of metering systems are suitable for certain ratios and flow rates of the two components. Accuracy tends to decrease for ratios exceeding about 20 to 1, where one component is a high volume component, and the second component is a low volume component. Also, accuracy tends to decrease for low flow rates when the low volume component decreases below about 20 cubic centimeters per minute (cc/min). In painting using in-line methods, the in-line mixing is limited to two components.

Separate lines of a base component and a catalyst component are fed into a small mixing chamber. The control of flow to the mixing chamber is with adjustable valves to ensure the proper mix ratio.

Some drawbacks with the batch methods include excess waste and difficulty of use. Drawbacks with the in-line methods include difficulty of control over mixture ratios when ratios are large, and inability to have more than two fluids. Further, expensive valves for control of the flow are required, and the catalyst component is generally inadequately mixed with the base component.

Thus, it is desirable in the present invention to provide a multi-component metering system which advantageously provides for greater control of metering and mixing of three or more fluids. It is a further desirable in the present invention to provide in-line mixing, thereby advantageously reducing waste of chemicals.

### SUMMARY OF THE INVENTION

The present invention provides an apparatus for mixing a plurality of fluids to form a mixture. The invention includes a plurality of metering cylinders, with each cylinder in fluid communication with one of the sources of fluid.

The invention further includes a plurality of levers, with each lever pivotally operating one of the metering cylinders. Each cylinder is positioned along the length of the corresponding lever for adjusting the stroke of the cylinder. A single actuator moves the plurality of levers in unison. This invention provides for simple and efficient control of metering any number of fluids to form a predetermined mixture.

The invention may further include a plurality of fluid sources. The flow of the fluids is controlled by the metering cylinders, and the fluids are received from the metering cylinders into a chamber for mixing. The metering cylinders may include spherical elastomeric check seals or any other materials of construction. The elastomeric check seals provide for a better seal in cases involving fluids with lower viscosity. The control of the selection of fluids may further be controlled by a mix manifold. The mix manifold is a shut-off station for maintaining isolation of the individual fluids. The invention may also include a static mixer or other mixing methods for mixing the fluids from the receiving station. Control of flow to the receiving station may also include check valves. The check valves prevent backflow of the mixture into the individual fluid lines. The check valves may include spherical elastomeric check seals or any other materials of construction. The invention may further include that a plurality of actuators may be employed to move the plurality of levers for increased flexibility in flow rate and rationing of the materials. These actuators may be of many different types, including but not limited to air cylinders and motors of varying types.

The invention may further include pressure regulators downstream of the static mixers for controlling pressure of a mixture to be dispensed, into a reservoir and/or at least one or more dispensers for dispensing the mixture. A filter may be installed upstream of the pressure regulator and the application dispenser. The filter may advantageously prevent clogging of the pressure regulator and the dispenser during the dispensing of the fluid mixture.

### BRIEF DESCRIPTION OF THE DRAWINGS

The description herein makes reference to the accompanying drawings wherein like reference numerals refer to like parts throughout the several views, and wherein:

FIG. 1 is a fluid circuit diagram for the present invention;

FIG. 2A is a top view of a metering cylinder of the present invention;

FIG. 2B is a partially cut away cross-sectional view of the cylinder taken on line 2B-2B of FIG. 2A, and showing the maximum stroke in phantom;

FIG. 3 is a top view of the metering assembly of the present invention;

FIG. 4 is a side view showing the lever bars, the metering cylinders, and the prime mover and the inter-relationship therebetween;

FIG. 5 is a schematic view of the base component pressure vessel and drain system;

FIG. 6A is an end view of a check valve adaptor to the metering cylinder inlet valve;

FIG. 6B is a side view of the check valve adaptor of FIG. 6A;

FIG. 7 is a schematic view of the static mixers and multiple dispensers; and

FIG. 8 is a diagram of a pneumatic control system for the invention.

### DETAILED DESCRIPTION OF THE PREFERRED EMBODIMENT

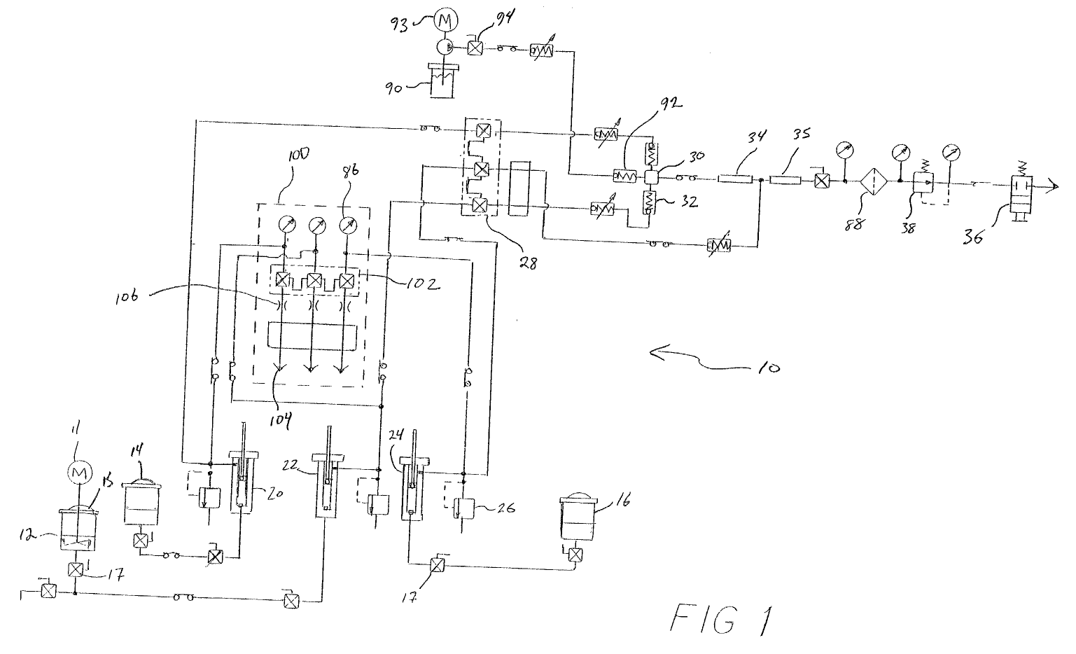

The invention is directed to an apparatus, generally referred to as 10, for mixing a plurality of fluids to form the mixture and applying the mixture. Referring to FIG. 1, a plurality of sources of fluids is supplied from supply equipment 14, 15, 16. The fluids flow from the sources, and the ratios of flow are controlled by the metering cylinders 20, 22, 24 with each cylinder in fluid communication with one of the sources of fluid. The plurality of fluids are transported between the stations by separate pipes or tubes. The metering cylinders 20, 22, 24 are controlled by a plurality of levers 74, with each cylinder 20, 22, 24 controlled by a separate lever 74. The movement of the levers moves pistons in each cylinder, displacing fluid as the pistons move up and down in the cylinders 20, 22, 24. The amount of movement of each piston is controlled by the relative position of the corresponding metering cylinder 20, 22, 24 along the length of the corresponding lever from a common axis of rotation. The levers are controlled and driven in unison by a single actuator, and the fluids are fed from the metering cylinders 20, 22, 24 into a single receiving chamber 30. The flow of the fluids may further be controlled by a mix manifold 28 for selection of the fluids passing through the apparatus 10. The mix manifold 28 is a shut-off station for maintaining isolation of the individual fluids. The fluids flow from the metering cylinders 20, 22, 24, through the mix manifold 28, and merge in a receiving chamber 30. Flow from the receiving chamber is further controlled by check valves 32 to prevent back flow of the mixture into the separate fluid pipes. The fluid from the receiving chamber is mixed with mixers 34, and flows to at least one dispenser 36 for dispensing of the mixture. The rate of the flow out of dispenser 36 is further controlled by a pressure regulator 38. The dispenser 36 may be an application valve; and the terms hereinafter are used interchangeably herein.

In a preferred embodiment, the sources of fluid are pressurized vessels 14, 15, 16. The individual fluids are placed in the individual pressure vessels 14, 15, 16, the vessels 14, 15, 16 are sealed, and the vessels 14, 15, 16 are pressurized with air. In an alternative, the vessels 14, 15, 16 are pressurized with any inexpensive gas capable of being pressurized to a high pressure without liquefying and with minimal dissolution in the fluids. Preferably the gases are nonflammable and are chosen to be non-reactive with the fluids in the apparatus 10. The fluids are driven by pressure to the metering cylinders 20, 22, 24. The metering cylinders 20, 22, 24 control the flow rate to a mixing manifold 28. The pressurized vessels 14, 15, 16 provide for portability of the apparatus 10. Although pressurized vessels 14, 15, 16 are specified, other methods that will supply fluids are envisioned to be encompassed by this invention. Among the other methods are various pumping systems such as diaphragm or drums, gravity feed systems, or other suitable devises for supplying a steady flow of fluids to each of the metering cylinders 20, 22, 24. The fluids are delivered to the cylinders 20, 22, 24 at a net positive pressure such that cavitation will not occur within the metering cylinders 20, 22, 24. The metering cylinders 20, 22, 24 and the pressurized vessels 14, 15, 16 can be isolated by shut-off valves 17. The isolation provides for convenient replacement and/or repair of the metering cylinders 20, 22, 24. The isolation also provides for convenient replacement or depressurization of one or more of the pressurized vessels 14, 15, 16 should more fluid need to be added to a pressurized vessel 14, 15, 16 without depressurizing the system.

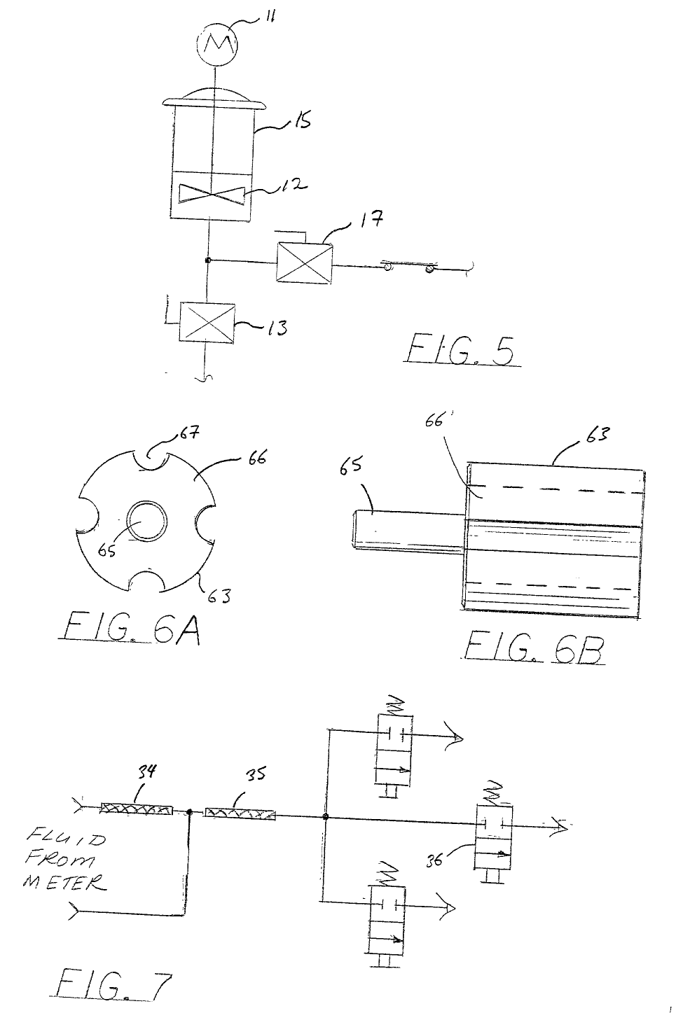

In a specific embodiment, when one or more of the individual fluids includes a suspension containing solid particles, or immiscible liquid droplets, it is desirable to maintain the suspension. A pressurized vessel 15, as shown in FIGS. 1 and 5, includes an agitator 12. The agitator 12 maintains the suspension by continuously stirring the fluid during use of the apparatus 10.

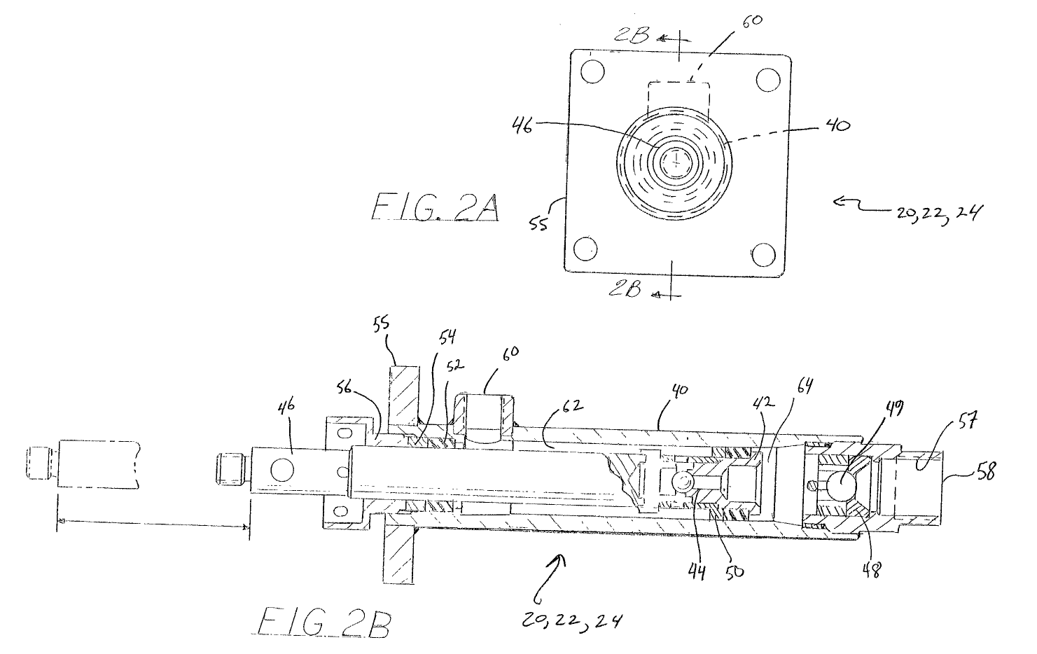

In a preferred embodiment, the metering cylinders 20, 22, 24 are positive displacement precision pumps of the double acting, reciprocating type. FIG. 2A is a top view of a metering cylinder 20, 22, 24 showing the plane for a cross-sectional view as shown in FIG. 2B. The outlet port 60 is below the flange 55 at the top of the metering cylinder 20, 22, 24. The top of the rod 46 protrudes above the flange 55, while the cylinder 40 is below the flange 55. Each metering cylinder 20, 22, 24 includes a cylinder 40, a piston 42 with an internal check valve 44 which is attached to a metering rod 46, an inlet check valve 48 located at the inlet end of the cylinder, seals for the piston 42, seals for the rod 52, rod bearing 54, and a packing nut 56 to retain the rod seals and bearings. The cylinder 20, 22, 24 also includes an inlet port 58 and a discharge port 60 for flow into and out of the cylinder 20, 22, 24 respectively. The seals 50, 52 for the pistons 42 and for the rod 46 are to prevent fluid from leaking around the sides of the piston 42 or the rod 46. During the operation of the metering cylinder 20, 22, 24, the rod 46 is moved in and out of the cylinder 40, and the piston 42, connected to the rod 46, slides up and down within the cylinder 40. Within the cylinder 40, there are two cavities, one cavity 62 above the piston 42 and one cavity 64 below the piston 42. As the rod 46 is retracted from the cylinder 40, the internal check valve 44 within the piston closes through the pressure differential created. The fluid volume in the cavity 62 above the piston 42 is then decreasing, creating a fluid discharge out of the discharge port 60. At the same time, the pressure differential across the inlet check valve 48 causes the inlet check valve 48 to open and fluid from the source of fluid to flow into the cavity 64 below the piston 52. After the rod 46 has been retracted from the cylinder 40, the motion of the rod 46 is reversed, and the rod 46 is pushed back into the cylinder 40.

In FIG. 2B the rod 46 is shown in the inserted position in the cylinder 40, and the maximum stroke is shown in phantom. When the rod 46 reverses motion, the inlet check valve 48 is closed by the pressure differential within the cylinder 40, and the internal check valve 44 within the piston 42 opens. The fluid volume in the cavity 64 below the piston 42 decreases, flowing through the internal check valve 44 to the cavity 62 above the piston 42 from the cavity 64 below the piston 42. The volume displaced in the cavity 64 below the piston 42 is twice the volume created in the cavity 62 above the piston 42. This creates a continuous, steady flow out the discharge port 60. When the rod 46 is pushed into the cylinder 40 to the extent of each stroke, the cycle of moving the piston 42 up and down is repeated. The check valves 44, 48 include a spring, or other means, for forcing check seals against the valve seats. The check seals are typically spherical seals, hereinafter referred to as check balls 49. The check seals can also be cylindrical seals with hemispherical or conical heads for mating with the valve seats.

Typical metering cylinders 20, 22, 24 have hardened steel check balls 49, and fluids of low viscosity tend to leak past the steel check balls 49. In sharp contrast, the invention uses elastomeric check balls 49 which advantageously allows the internal pressure to conform the check balls 49 to the valve seats. The use of elastomeric check balls 49 provides for more accurate metering of the fluids by reducing errors due to leakage around the check balls 49. The housing for the inlet check valve 48 to the metering cylinder includes a unique adaptor 66. FIG. 6A shows an end view of the adaptor 66, and FIG. 6B shows a side view of the adaptor 66. The adaptor 66 has channels 67 for fluid to flow around the adaptor 66. A post 65 extends up to the check ball when the check ball is against the valve seat of the inlet valve 48. The adaptor 66 is sized to have the same diameter as the inlet port 58, such that the outer edge 63 of the adaptor is in contact with the inner surface 57 of the inlet port 58. The post 65 has a diameter less than the diameter of the opening in the valve 48. The adaptor 66 fits in the inlet port 60 of the metering cylinder 20, 22, 24 and prevents the elastomeric check ball 49 from deforming into the opening in the valve seat by acting as a limit stop on the check ball 49 while not preventing the check ball from conforming to the valve seat, thus preventing the check ball 49 from being extruded past the check valve seat. This substantially prevents failure of the inlet valve 48. The adaptor 66 may include other shapes so long as the basic requirements are met. The basic requirements of the adaptor 66 include a fit within the inlet port 58 to prevent motion of the adaptor 66, channels 67 for fluid to flow around the adaptor 66, a post 65 extending from the main body of the adaptor 66 to the opening in the inlet valve 48, wherein the post may have any shape which permits flow through the opening in the inlet valve 48. The metering cylinders 20, 22, 24 are manufactured from stainless steel, or are plated or otherwise treated to resist corrosion. Other components of the apparatus 10 are also manufactured from stainless steel, plated or otherwise treated for corrosion resistance, or manufactured from material chosen to withstand the particular fluids used in a particular application.

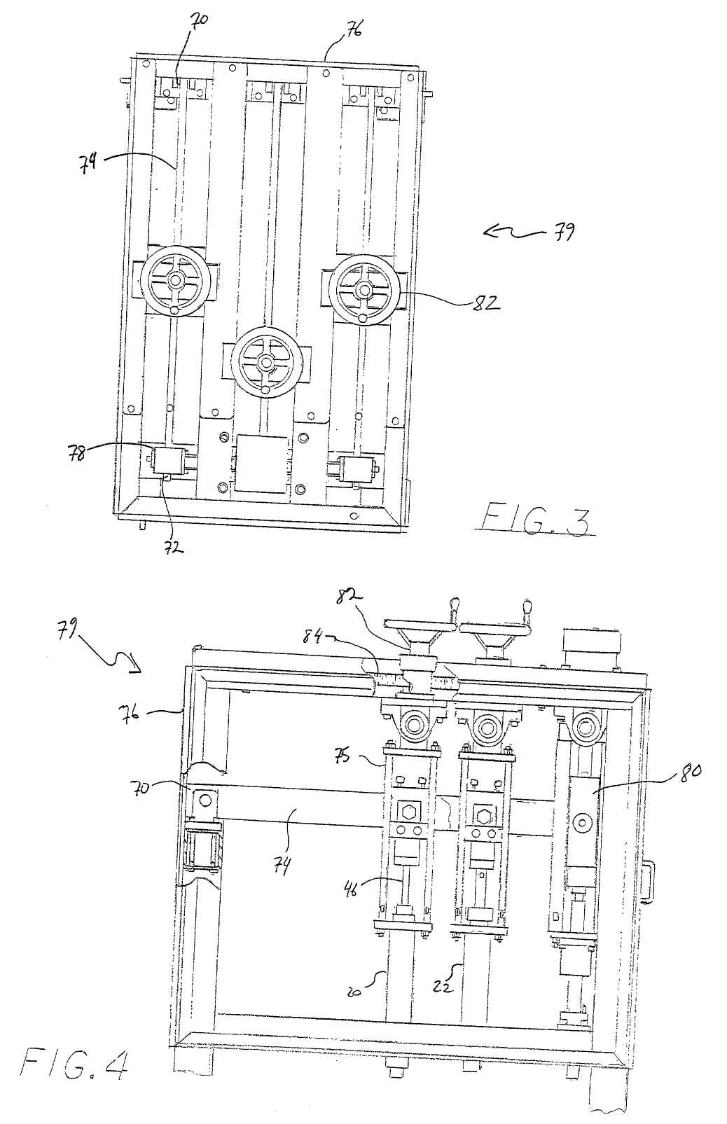

The metering cylinders 20, 22, 24 are controlled by levers 74, each lever 74 pivotally operating at least one cylinder, and each lever having a first end 70 and a second end 72. The plan view of the invention, as shown in FIG. 3, has the plurality of levers 74 aligned with the first end 70 of each lever pivotally attached to a frame 76. The second end of each lever is attached to a drive linkage 78, which is in turn attached to an actuator 80. Movement of the actuator 80 moves the second end 72 of all of the levers 74 in unison. As shown in FIG. 4, each metering cylinder 20, 22, 24 is connected to the frame 76 at the base of the cylinder, and the rod 46 of each metering cylinder 20, 22, 24 is connected to the lever 74. Each metering cylinder 20, 22, 24 is preferably connected to the frame 76 by a sliding connection, such that each cylinder slides toward or away from the actuator 80 when adjustments are made to the position of the metering cylinders 20, 22, 24 along the length of the levers 74. In an alternative, the metering cylinders 20, 22, 24 may be pivotally attached to the frame 76 at the base of the cylinder 20, 22, 24. Movement of the actuator 80 then drives all of the metering cylinders 20, 22, 24. The position of the cylinder 20, 22, 24 along the lever determines the length of the stroke of the rod 46 and motion of the piston 42 within the cylinder 20, 22, 24. By positioning each cylinder 20, 22, 24 on a different lever, excellent control is provided over the ratios of flows of fluids from the different fluid sources. Each metering cylinder 20, 22, 24 is attached to a corresponding lever 74 with a bracket system 75 for sliding the position of attachment along the lever 74. The bracket system 75 is moved by a gear system controlled by a hand wheel assembly 82. The position is marked by a pointer on the bracket system 75, and which points to a linear scale 84 attached to the frame 76. Each metering cylinder 20, 22, 24 is with a separate bracket system 75 and linear scale 84 for individual setting of the cylinders 20, 22, 24. With the individual linear scales 84, an operator can change ratio settings quickly and precisely, as well as return to prior ratio settings, with minimal time and effort. This provides a high degree of precision in controlling the setting for the length of the stroke of the cylinders 20, 22, 24 and subsequent control of mixing quantities. In addition this provides for a wider range of ratios of the fluids mixed to be realized. The metering cylinders 20, 22, 24, the levers 74, the drive linkage 78 and the actuator 80 define a metering assembly 79. Additional control over the ratios of fluids mixed is obtained through the sizing of the metering cylinders 20, 22, 24, especially when mixing ratios are very large.

The fluid from the metering cylinder 20, 22, 24 outlet ports 60 flow to a mix manifold 28 for further control, determining which fluids are selected to be mixed and dispensed. The mix manifold 28 allows for setting up many fluids for different applications where the selection of fluids for a given application is set by opening or closing the appropriate valves on the mix manifold 28. The mix manifold 28 maintains isolation of the individual fluids as the fluids pass through the manifold 28 and is a station providing the capability of shutting off individual fluid lines. Pressure gauges 86 are supplied to display individual fluid pressures for monitoring the apparatus 10 during operation. The fluids flow from the mix manifold 28 through one-way check valves 32 to a receiving chamber 30. The check valves 32 prevent fluid from the receiving chamber 30 from flowing back into individual fluid lines, and prevents contamination of unused individual fluids. As an alternative, when the fluids have high viscosities, the check valves 32 are replaced with power valves. The power valves may be air operated with electrical controls to sequence the opening and closing of the valves. The receiving chamber 30 is a pipe with an inlet port for each fluid component in the system. The mixed fluids in the receiving chamber 30 are then passed through at least one mixer 34 to provide a uniform, well blended mixture. When the mixture includes at least three fluids, the mixing preferably involves sequencing the mixing of fluids with multiple mixers 34, 35 and injection ports. An example of a mixing sequence would be to blend the two fluids with the highest viscosities in a mixer 34, then injecting the remaining fluids and blending the resultant mixture in a second mixer 35. The number of mixers and the sequencing of the blending will depend on the number of fluids mixed and the properties of the fluids. In general, the most relevant property will be the viscosity. In a preferred embodiment, mixing is done with static mixers 34,35. Static mixers 34, 35 provide excellent blending of fluids to form a uniform mixture, and have the advantage of being relatively inexpensive and without moving 15 parts. This provides for low maintenance. In an alternative, should the fluids being mixed have difficulty with blending in static mixers 34, 35, dynamic mixers are used.

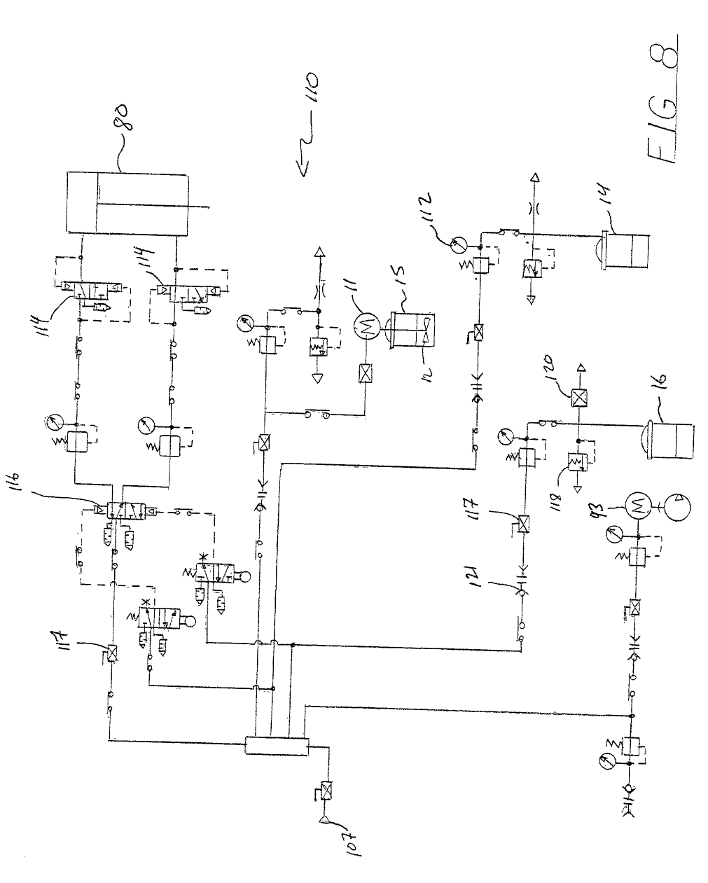

In an alternative embodiment, a filter 88 is provided. The filter is sized to filter out agglomerations in the fluid mixture to avoid clogging of orifices in the application valves 36. The filter 88 is also sized to permit the passage of suspended solids in the fluid mixture. The application valves 36 are operated at lower pressures than provided for by the system, and therefore a pressure regulator 38 is installed just upstream of the application valves 36 to reduce the pressure of the fluid mixture to a level compatible with the application valves 36. The apparatus 10 is readily adaptable to multiple dispensers 36, as shown in FIG. 7. As an option, should the individual dispensers 36 require different levels of pressure, each can be adapted with individual pressure regulators 38 for individual control of the pressure reductions.

The apparatus 10 may include a fluid purge system. The receiving chamber 30 has an inlet port for a fluid solvent from the fluid purge system. Since the mix manifold 28 maintains isolation of the individual fluid components upstream of the receiving chamber 30, the apparatus 10 only needs a purging solvent to clean the apparatus 10 from the receiving chamber 30 to the dispensers 36. This minimizes the amount of fluid solvent used and waste produced. The fluid purge system will include a supply system or reservoir 90 for the fluid solvent, for purging the system downstream of the receiving chamber 30 of any mixed fluid components. The typical solvent for a water based paint mixing system is water. The fluid purge system includes means for moving the fluid solvent into the fluid receiving chamber 30 and a check valve 92 for preventing back flow of the mixture when the fluid purge system is not in operation. The purge system removes mixed fluids from the system, enabling the system to be used with another mixture without having contaminants from an earlier mixture. The means for moving the fluid solvent can include pressurizing the solvent reservoir 90, or providing pumping means to move the solvent through the system. The fluid purge system can also include a shut off valve 94 to close the fluid purge system when the purge system is not in use. As an alternative to a pump and reservoir, a base fluid purge circuit is used.

In an alternative, the apparatus 10 includes a ratio sampling station 100. The ratio sampling station 100 is downstream of the plurality of metering cylinders 20, 22, 24, but upstream of the manifold shut-off station 28. The ratio sampling station 100 includes a ratio sample manifold shut-off station 102 for selection of fluids and checking of the ratios of the fluid mixtures. The ratio sampling station also includes a flow control valve 104 for each fluid metered and restrictor valves 106 for maintaining fluid back pressure. Pressure gauges 86 are provided to display the individual fluid pressures. This provides a simple testing and check on the mixing of the fluids to determine if the appropriate ratios are correct from the metering cylinders 20, 22, 24, and to provide access to the fluids from the metering cylinders 20, 22, 24 during ratio sampling procedures.

Preferably, the levers 74 are driven by a single actuator 80. In a preferred embodiment, the actuator 80 is an air cylinder and drives the levers 74 in an up and down motion. In an alternative configuration, the actuator 80 can be a servo-motor, a hydraulic cylinder, or any other means for performing a reciprocating motion. The actuator 80 is connected to the levers 74 by drive linkage 78. A lateral bearing assembly interfaces with the drive linkage 78 which off-sets the side 10 loads created by the levers 74 being driven by the actuator 80. This feature improves operation and facilitates a single actuator 80 rather than multiple actuators, and provides the ability to use the full stroke of any metering cylinder 20, 22, 24. By linking all metering cylinders 20, 22, 24, through the corresponding levers 74 to a single actuator 80, and adjusting each cylinders 20, 22, 24 metering flow by position along the lever 74, greater control and more precise ratios of fluids to be mixed is achieved. As an option, shut off valves 17 are included in the system for shutting off or isolating sections of the system. This permits selective maintenance or substitutions without shutting down the entire apparatus 10.

The control of the apparatus 10 is through a pneumatic control system 110 as shown in FIG. 8. A high pressure air supply 107 provides pressure to the pressurized vessels 14, 15, 16. Regulators 112 control the amount of pressure to the pressurized vessels. The agitator 12 may be controlled by an air driven motor 11. When the actuator 80 is an air cylinder, the pneumatic control circuitry includes pilot valves 114 and a directional valve 116, for enabling the operation of the air cylinder 80 in a reciprocating manner. The high pressure air supply 107 also supplies air to the fluid purge system. The air pressure is used to drive an air driven motor 93 connected to the flush pump, or in an alternative configuration, the air is used to pressurize the fluid purge system reservoir 90. Shut off valves 117 enable isolation of the actuator 80, or the pressurized vessels 14, 15, 16 should maintenance or replacement be required. This can be done without shutting the pneumatic system 110 completely down, saving on the time and cost to repressurize the pneumatic system 110. In addition to the shut off valves 117, the pneumatic system 110 has quick connect couplings 121 for ease of substitution of pressurized vessels. The high pressure air 107 is supplied by a high pressure air cylinder, or in an alternative is supplied by an air compressor.

In an alternative embodiment, the pneumatic control system 110 is replaced with electrical controls, or other suitable control system. The use of electrical controls readily enables the substitution of an electric motor for the air cylinder as the actuator 80. Electrical controls provide for the substitution of pumps in place of pressurizing means for the fluid supplies and the fluid purge system. In addition, an electrical control system permits the use of an electric motor to drive an agitator 12.

Protection for the apparatus 10 is provided in the form of pressure relief valves 118. This includes automatic pressure relief valves 118 and manual control through manual pressure bleed valves 120. This prevents over pressurizing the system or parts of the system. Additional protection is provided with rupture disk assemblies 26, for the protection of the metering assembly 79, and in particular the metering cylinders 20, 22, 24. The rupture disk assemblies 26 provide relief in case of the closing of shut-off valves downstream of the metering cylinders 20, 22, 24 before shutting the actuator 80 down.

In a specific embodiment, the apparatus 10 of the invention is directed to a three component paint mixing and dispensing system. Referring to FIG. 1, this system includes three sources of fluids, a base paint component pressure vessel 15 with an agitation means 12, a catalyst paint component pressure vessel 14, and a water component pressure vessel 16. The apparatus includes three double acting positive displacement metering cylinders 20, 22, 24, one for each fluid component. The double-acting positive displacement cylinders are each operated pivotally by a lever 74 connected to a drive linkage 78. All the levers 74 are driven by a single actuator 80 which includes an air cylinder for driving the three levers 74 in unison in an up and down motion. The base paint component and the catalyst paint component are fed to a receiving chamber 30 and mixed with a static mixer 34. After mixing of the paint components, water is injected. The mixed paint components are then mixed with water in a second static mixer 35 for producing the final paint mixture. The paint mixture is filtered and delivered through an application valve 36. A typical application valve 36 is a spray gun. The control of the flow to the application valve 36 is regulated by a pressure regulator 38. It was determined that to obtain satisfactory paint spray patterns, the mixed fluids had to be filtered, to avoid clogging the orifice of the application valve 36. In addition, the pressure regulator 38 was installed to reduce the fluid pressure presented to the application valve to a level the application valve can handle.

The base paint component includes an agitation means. The agitator 12 helps to keep solids constituents of the base paint in suspension while contained within the base paint component pressure vessel 15. The agitator blades contained in the pressure vessel were replaced with special blades which extend much closer to the inner wall of the pressure vessel 15 than the original blades. The agitator blades preferably extend to within about 1 mm to about 25 mm of the inner wall of the vessel 15, thereby eliminating the problem of the base paint fluid clinging to the inner wall of the vessel 15. The agitator blades more preferably extend to within about 3 mm to about 10 mm of the inner wall of the vessel, and most preferably extend to within about 4 mm to about 6 mm of the inner wall. The base paint vessel 15 includes a drain 13. The drain 13 includes a ball drain valve and nipple, as shown in FIG. 5. This provides the ability to purge the vessel 15 after periods of non-use, and prevents fluid that has separated from being processed by the metering cylinder 20, 22, 24, and which can have a negative effect on ratio and application. As an alternate the base paint vessel 15 is purged after termination of use of the apparatus 10. As an option, the entire paint system is located on a portable platform cart.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for metering fluids to be used to form a mixture comprising:
a plurality of variable displacement chambers, each chamber expandable and contractable between a minimum volume and an adjustable maximum volume for pumping fluid;
means for selectively adjusting the maximum volume of each chamber independently of one another; and
at least one actuator operatively connected to the chambers for moving the chambers between the minimum volume and maximum volume to pump an adjustable metered volume of each fluid to be mixed.

2. The apparatus of claim 1 wherein the adjusting means further comprises a coupling attached between each displacement chamber and the at least one actuator, the coupling adjustable for independently controlling individual maximum displacement volume from the corresponding chamber.

3. The apparatus of claim 1 further comprising:
a plurality of levers, each lever connectable to at least one chamber and pivotally attached to rotate about at least one axis.

4. The apparatus of claim 3 wherein the at least one axis is a common axis for the plurality of levers.

5. The apparatus of claim 1 wherein the plurality of displacement chambers further comprises a positive displacement metering pump.

6. The apparatus of claim 5 wherein each metering pump includes at least one associated check valve for controlling fluid flow into and out of each chamber.

7. The apparatus of claim 1 further comprising a plurality of fluid sources in fluid communication with the chambers.

8. The apparatus of claim 1 further comprising a receiving chamber in fluid communication with the plurality of chambers.

9. The apparatus of claim 8 further comprising at least one check valve between each displacement chamber and the receiving chamber.

10. The apparatus of claim 8 further comprising at least one mixer downstream of the receiving chamber.

11. The apparatus of claim 10 further comprising at least one filter downstream of the mixer.

12. The apparatus of claim 8 further comprising a fluid purge system in fluid communication with the receiving chamber.

13. The apparatus of claim 1 further comprising a ratio sampling station downstream of the plurality of chambers including a ratio sample manifold shut-off station, and a flow control valve for each fluid to be metered.

14. An apparatus for metering fluids to be used to form a mixture comprising:
at least three positive displacement metering chambers;
at least three motion transfer members, each motion transfer member operatively connected to at least one positive displacement metering chamber; and
at least one actuator operatively connected to the at least three motion transfer members for driving the positive displacement metering chambers to pump metered volumes of fluid to be mixed.

15. The apparatus of claim 14 further comprising:
a receiving chamber having an inner wall for receiving at least one of the fluids to be mixed; and
an agitator having agitator blades extending to within a range of about 3 mm to about 25 mm of the inner wall of the receiving chamber.

16. The apparatus of claim 14 further comprising:
a catalyst component vessel in fluid communication with at least one positive displacement metering chamber; and
a reducing component vessel in fluid communication with at least one positive displacement metering chamber.

17. The apparatus of claim 14 wherein the at least one actuator further comprises a single actuator for driving the at least three motion transfer members along a common path.

18. The apparatus of claim 14 further comprising at least one mixer downstream of the at least three positive displacement metering chambers.

19. The apparatus of claim 18 further comprising at least one filter downstream of the at least one mixer.

20. An apparatus for metering fluids to be used to form a mixture comprising:
means for metering at least two fluids in a selectable ratio with respect to one another through at least two variable displacement metering chambers having individual displacement volumes adjustable independently from one another;
at least two motion transfer members connected to the metering means; and
at least one actuator operatively connected to the at least two motion transfer members for driving the variable displacement chambers to pump metered volumes of at least two fluids to be mixed.
